(19) United States
(12) Patent Application Publication
(10) Pub. No.: US 2001/0033720 A1
(43) Pub. Date: Oct. 25, 2001

(54) SYSTEM AND METHOD FOR ALIGNING OPTICAL COMPONENTS

(76) Inventor: JAN ISAKSSON, TABY (SE)

Correspondence Address: BIRCH, STEWART, KOLASCH & BIRCH, LLP, P.O. BOX 747, FALLS CHURCH, VA, 22040-0747, US

(21) Appl. No.: 09/225,681

(22) Filed: Jan. 6, 1999

(30) Foreign Application Priority Data
Jan. 31, 1998 (GB) 9802048.0

(51) Int. Cl. G02B 6/42

(52) U.S. Cl. 385/92

(57) ABSTRACT

An optical die and method of using same passively mounted to a standard optical housing. The housing provides guide pins received within apertures of the die. The assembly facilitates accurate passive alignment.

### FIELD OF THE INVENTION

The present invention relates to a method and arrangement for aligning optical elements and more particularly, the present invention relates to a method and apparatus for aligning optical components in standard optical housings.

### BACKGROUND OF THE INVENTION

Presently, many types of optical housings are available for transmitting and receiving optical transmissions such as ST, FC, SMA, and SC. As is known, each of the housings creates peculiar alignment difficulties with respect to the optical transmission medium and the optical power transfer medium. Alignment between the media is paramount to output, wavelength and other physical properties.

Prior art techniques have not addressed the complications inherent with alignment and accordingly, manufacturers perform active alignment escalating the cost of assembly.

The present invention provides a guide arrangement for guiding alignment of the fibre optic component with the housing. The guiding apparatus cooperates with apertures associated with the die mounted optical elements to ensure positive alignment.

### SUMMARY OF THE INVENTION

In accordance with one aspect of one embodiment of the present invention, there is provided an optoelectronic assembly, comprising:

an optical member;

a frame for the optical member including electroconductive members for providing power to the optical member, the optical member having apertures; and

an optical housing including guide means projecting therefrom, the guide means for guiding alignment of the frame thereon; whereby the frame, when positioned on the guide means, is passively aligned with the housing.

The optical member may comprise a framed optical die with apertures in the frame formed by photolithography or other suitable techniques which ensure alignment of the optoelectronic device relative to the apertures.

The technique disclosed herein may be applied to any optical housing.

According to a further aspect of the invention, there is provided a method for passively aligning an optical member with an optical housing comprising the steps of:

forming projections on the housing;

providing the optical member with apertures for engagement with a respective projection of the projections; and

positioning the optical member on the projections, whereby the optical member is passively aligned with the housing.

Having thus generally described the invention, reference will now be made to the accompanying drawings illustrating preferred embodiments.

### BRIEF DESCRIPTION OF THE DRAWINGS

FIG. 1 is a cross section of a standard optical connector;

FIG. 2 is a side elevation view of the connector in accordance with one embodiment of the present invention;

FIG. 3 is a plan view of the lead frame for receiving an optical die; and

FIG. 4 is a perspective view of the optical member as positioned on the housing.

Similar numerals employed in the text denote similar elements referenced in the text.

### DETAILED DESCRIPTION OF THE PREFERRED EMBODIMENTS

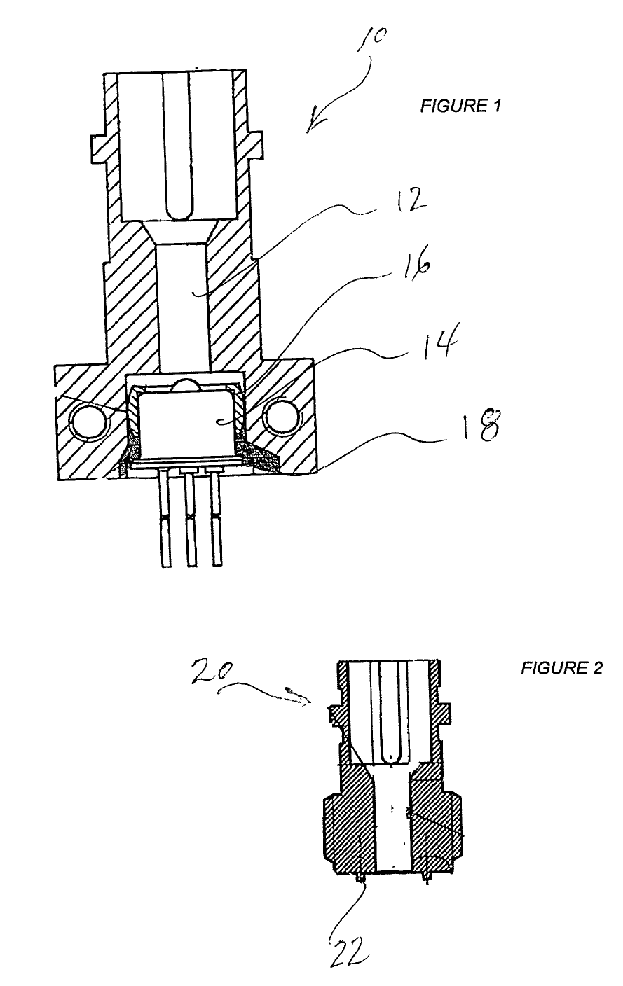

Referring now to FIG. 1, numeral 10 generally denotes a standard ST connector. As is known, ST connectors provide an insert 12 for a ferrule (not shown). Connector 10 mounts an optical device 14 on a ring 16. This arrangement facilitates adjustment of the optical device 14 within ST connector 10. Once member 14 is in the most effective position, it is fixed with, for example, adhesive 18 in connector 10. This active alignment of optical member is time consuming and costly. The connector illustrated in FIG. 2 overcomes the limitations associated with active alignment.

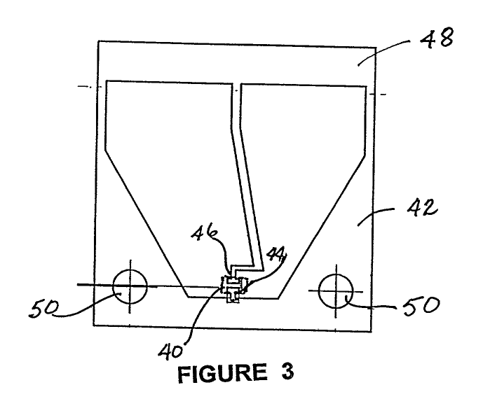

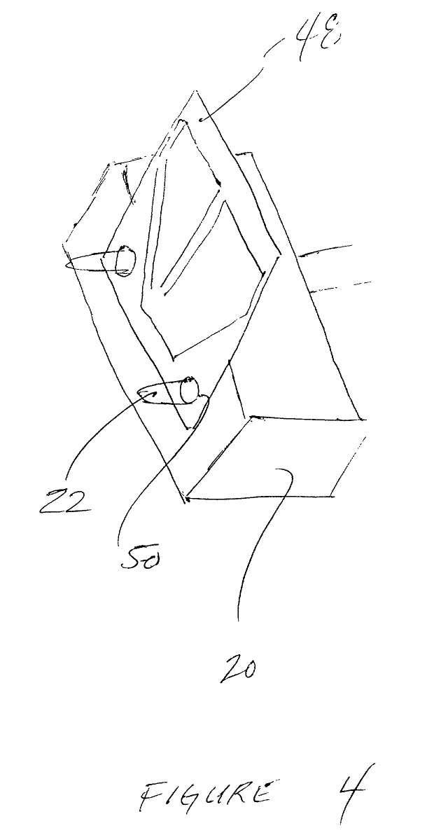

Referring now to FIG. 2, a modified connector is illustrated in cross section. The connector 20 includes guides 22 at the position which would normally receive the optical device 18 shown in FIG. 1. The guides may comprise projections as illustrated in the example, however, the precise configuration will depend on the specific application. Guides 22 are employed to passively align an optical die having optoelectronic elements. These elements are shown in FIG. 3.

The optical die shown in FIG. 3 provides a laser diode 40, shown in dotted line in FIG. 3. A carrier or lead frame 42 is connected to the substrate and to laser diode 40 via contact pads 44 and 46. This configuration permits flip-chip bonding of laser diode to the pads while permitting the surface emitting laser to provide a collimated beam in a direction away from the plane of the contacts. As is known, the end strip 48 is removed after the laser has been attached and the package otherwise completed in order to isolate the two pads 44 and 46.

Lead frame 42 also h as holes 50 which are precisely aligned in relation to the bonding pads 44, 46. The holes 50 facilitate passive alignment with guides 22.

FIG. 4 illustrates an assembled unit.

In assembly, one or more laser diodes may be attached to the appropriate lead frame by flip-chip bonding techniques. The lead frame is clipped to remove the shorting strip and contacts are made to the power connections by well known means. Some form of protection such as encapsulation or protection plate will support the laser diode array and protect the surface-emitting lasers. Because surface-emitting lasers emit a collimated beam, no optical elements are required in order to obtain good optical coupling of optical power into the optical fibre.

By making use of the guides 22 flip-chip metal frame mounted components are easily and passively aligned to any typical optical housing with high accuracy.

Other securing means to hold the two components in mating engagement may be used if desired.

With respect to the description of the laser diode, it will be readily appreciated that this is exemplary only. The invention is readily applicable to any active optoelectronic die or semiconductor. An example of such a device is a pin diode or other transmitting/receiving active device.

While particular embodiments of the invention have been disclosed and illustrated, it will be apparent that certain variations can be made to the basic concept. It is intended that such variations will fall within the scope of the present invention as defined by the appended claims.

Although embodiments of the invention have been described above, it is not limited thereto and it will be apparent to those skilled in the art that numerous modifications form part of the present invention insofar as they do not depart from the spirit, nature and scope of the claimed and described invention.

I claim:

1. An optoelectronic assembly, comprising:
an optical member;
a frame for said optical member including electroconductive members for providing power to said optical member, said optical member having apertures; and
an optical housing including guide means projecting therefrom, said guide means for guiding alignment of said frame thereon; whereby said frame, when positioned on said guide means, is passively aligned with said housing.

2. The assembly as set forth in claim 1, wherein said guide means comprises a pair of pins extending from said housing.

3. The assembly as set forth in claim 1, wherein said housing is selected from the group comprising ST, FC, SMA and SC.

4. The assembly as set forth in claim 2, wherein said housing is selected from the group comprising ST, FC, SMA and SC.

5. The assembly as set forth in claim 1, wherein said optical member comprises a surface emitting, light emitting diode.

6. The assembly as set forth in claim 2, wherein said optical member comprises a surface emitting, light emitting diode.

7. The assembly as set forth in claim 3, wherein said optical member comprises a surface emitting, light emitting diode.

8. The assembly as set forth in claim 1, wherein said optical member comprises a surface emitting laser.

9. The assembly as set forth in claim 1, wherein said optical member includes a plurality of optical members and said ferrule includes a plurality of fibers, said fibers and said members being in common spaced relation.

10. A method for passively aligning an optical member with an optical housing comprising the steps of:
forming projections on said housing;
providing said optical member with apertures for engagement with a respective projection of said projections; and
positioning said optical member on said projections, whereby said optical member is passively aligned with said housing.

11. The method as set forth in claim 10, wherein said optical member includes a frame surrounding an optoelectronic device.

12. The method as set forth in claim 10, wherein said apertures are formed by photolithography.

13. The method as set forth in claim 11, wherein said apertures are formed by photolithography.

14. The method as set forth in claim 10, wherein said projections are machined on said housings.

15. The method as set forth in claim 14, wherein said projections are machined on said housings.

16. The method as set forth in claim 15, wherein said projections are machined on said housings.

17. The method as set forth in claim 16, wherein said projections are machined on said housings.
